(19) United States
(12) Patent Application Publication
(10) Pub. No.: US 2003/0171987 A1
(43) Pub. Date: Sep. 11, 2003

(54) Method and system for circulating and redeeming credits according to a decumulation program

(76) Inventors: Massimo Amato, Milano (IT); Luca Fantacci, Milano (IT)

Correspondence Address: MODIANO & ASSOCIATI, Via Meravigli, 16, 20123 MILANO-ITALY, MILANO, IT

(21) Appl. No.: 10/093,418

(22) Filed: Mar. 11, 2002

(51) Int. Cl. G06F 17/60

(52) U.S. Cl. 705/14

(57) ABSTRACT

A method of managing and circulating credits within the members of a credit circuit, an amount of credits being issued by a participant enrolled in a first category of the circuit to at least one participant enrolled in a second category of the circuit, the issue being based on transaction data, wherein the credits are subject to an automatic transfer process according to a time-based algorithm.

### BACKGROUND OF THE INVENTION

The present invention relates to a method and system for managing credits, such as loyalty points, discount bonuses, vouchers or the like, issued by conveniently authorized members enrolled in a clearing union or promotion program.

Several forms of business commercial programs and methodologies are nowadays employed to promote sales, by influencing consumer behavior through incentives.

Many reward programs and systems based on loyalty points or discount bonuses are known in the art. All of them aim at attracting a large number of consumers and/or making them loyal to some kind of business: a store, a market-chain, a company, a brand etc. Such promotions are currently applied both to offline and online sales.

“Frequent flyer” programs are a typical and well known example of such loyalty programs. Points issued by a flight company are awarded to a customer each time the customer flies with the company. When a certain amount of points is reached, the participant is entitled to a flight or to other services offered by the same company, for free or at a discount price.

On the other hand, it is known that there is a need for nonprofit organizations to raise funds. This includes fundraising carried out periodically as a yearly event, like the “Telethon” program or the “Comic Relief”, and cause related marketing, for instance the “Avon crusade against breast cancer”.

The cited programs apply different methods and techniques to encourage consumers to spend money—in one case so as to increase the market share and strength of a company, in the other in order to raise funds for charities.

However, existing programs suffer from major disadvantages, both for the commercial businesses and for the nonprofit organizations.

In the above mentioned promotion programs, a bond is established between the company issuing the loyalty points or discount bonuses and the customer. This is expressly intended by the company to attract and retain customers. However, recent surveys have shown that loyalty programs do not actually produce loyalty or do so with poor results. A Jupiter Communications survey of 1200 US online consumers reports that 75% belong to some loyalty program, but only 22% feel affected in their purchase behavior. Therefore, when the consumer is bound to redeem the points with the same business that issued them, this often results in a significant stagnation or virtual death of the points gained, with no or little benefits both for consumers and the issuing company.

For instance, thousands of people have collected a number of “flight miles” which either grow in time at an unacceptably low rate or will never be used, since the required amount of points is not in the reach of the average flyer. These points become de facto useless both for the customer and the business, since a customer is not really encouraged to use a flight company rather than a competitor's company on the basis of points he will never be able to redeem: thus, the business is investing money for a service which is only partially effective.

For this reason, several airlines have established joint ventures with companies offering different services linked to travel, such as hotel or restaurant chains, so that their points could be redeemed for a larger choice of services. In this way, points and offers are pooled, but in most cases this happens merely on the basis of bilateral agreements.

From the perspective of consumers, a major problem both with online and offline promotions is given by the limited choice of goods they can select, as this choice is usually restricted to the items included in a prize catalogue.

Again, the problem is sometimes offset through bilateral agreements and joint ventures, but this extends the possibility of redeeming points only slowly and partially, without assuring the company the complete redemption of the points issued and without giving the consumer an actual freedom of choice as to the goods and services he can purchase with the points.

On the other hand, even the two fundraising methods described above (periodical campaigns and cause related marketing) suffer from disadvantages. Most noticeably, the fundraising campaigns have to be concentrated in a short period of time, for instance one or two weeks a year, which results in a poor performance in absolute terms. Moreover, they require an actual donation by the customer, who is pushed to adhere to the program only by his good will and conscience. Cause related marketing overcomes this problem by making the donation someway compulsory, and tying it to the actual purchase of a specific product: but this deprives the customer of the freedom to choose personally the charity he would like to benefit.

The proposed invention manages to overcome the structural limits of both conventional promotions and fundraising, by combining them in a unique integrated system which leads to substantially improved efficiency and effectiveness.

### SUMMARY OF THE INVENTION

The aim of the present invention is to overcome the problems and disadvantages affecting the state of the art, providing an improved method and system for managing promotions of commercial companies and nonprofit organizations, through a credit-based multilateral circuit.

Within this aim, an object of the present invention is to provide a method and a system that structurally prevent the tendency to stagnation of points and bonuses, boosting the rate of redemption.

Another object of the present invention is to provide a fully multilateral scheme, being based on one general agreement and not on a multiplicity of bilateral arrangements.

This aim, these objects and others which will become apparent hereinafter are achieved by a method of managing and circulating credits within the members of a credit circuit, an amount of credits being issued by a participant enrolled in a first category of the circuit to at least one participant enrolled in a second category of the circuit, said issue being based on transaction data, wherein the credits are subject to an automatic transfer process according to a time-based algorithm.

The aim and the objects of the present invention are also achieved by a system for managing and circulating credits within the members of a credit circuit, comprising means for enrolling participants, means for assigning the participants to a category and for assigning one or more credit accounts of different types to each of the participants, means for transferring credits from a first account to a second account according to transaction data, and means for automatically transferring credits from an account of a type to an account of a type according to a time-based algorithm.

A first automatic transfer process comprises the steps of retrieving first information data concerning the status of an account of type α of the participant in the second category; performing a computation based on time and on the first information data and transferring an amount of credits based on said computation from the account of type α to an account of type β of the participant in the second category.

Conveniently, the credits from the account of type of the participant in the second category may be restricted to transfers to an account of a participant in the first category or to an account of type of another participant in the second category, and credits from the account of type β of the participant in the second category may be restricted to transfers to an account of a participant in a third category or to an account of type of another participant in the second category.

Each category may comprise a plurality of merchants, consumers, nonprofit organizations, public corporations or a clearing center.

The amount of credits issued by the participant in the first category to the participant in the second category is preferably calculated according to criterions defined by the participant of the first category.

Credits can be transferred from the account of type α of the participant in the second category to an account of the participant in the first category in exchange of goods or services, from the account of type β of the participant in the second category to an account of the participant in the third category either as a donation or in exchange of goods or services.

Moreover, credits on the account of type of the participant in the second category can be cancelled by the clearing center after a period “m” of stagnation time, and redistributed to other participants; and credits on the account of the participant in the third category may be cancelled by the clearing center after a period “m” of stagnation time and redistributed to other participants.

### BRIEF DESCRIPTION OF THE DRAWINGS

Further characteristics and advantages of the present invention will become apparent from the following detailed description, given by way of non limitative examples and illustrated in the accompanying figures, wherein:

FIG. 1 is a schematic view showing the category of actors involved in the method and system according to the present invention;

FIG. 2 is a schematic view showing the operations that such actors may carry out in respect of one another;

FIG. 3 is a flow diagram of the automatic transfer processes according to the invention as claimed;

FIG. 4 is a flow diagram showing acquisition of credits supplied by the clearing center to one of the participants to the system, particularly a merchant;

FIG. 5 is a flow diagram showing how credits are issued by merchants and assigned to consumers;

FIG. 6 is a flow diagram illustrating the redemption of credits α by a participating member, particularly a consumer;

FIG. 7 is a flow diagram illustrating the donation of credits β by a participating member, particularly a consumer, to another participating member, particularly a nonprofit organization;

FIG. 8 is a flow diagram illustrating the redemption of credits by a participating member, particularly a nonprofit organization;

FIG. 9 is a flow diagram illustrating the transfer of credits from a first participating member to a second participating member of the same category;

FIG. 10 is a flow diagram illustrating the inventive concept underlying the present invention, wherein unused credits β are transferred from a first participant, particularly a consumer, to a number of other participants, particularly a number of different consumers;

FIG. 11 is a flow diagram illustrating the inventive concept underlying the present invention, wherein unused credits are transferred from a participant, particularly a nonprofit organization, to a number of other participants, particularly a number of different nonprofit organizations;

FIG. 12 is a schematic view showing the actors involved in the method and system according to a second embodiment of the present invention;

FIG. 13 is a schematic view showing the operations that such actors may carry out in respect of one another;

FIG. 14 is a flow diagram of the decumulation operations of the second embodiment, according to the invention as claimed;

FIG. 15 is a data flow diagram showing the inventive concept underlying the present invention;

FIGS. 16 and 17 are schematic views of illustrative client-server network systems according to the present invention;

FIG. 18 is a data flow diagrams illustrating how an enrollment and customization procedure interacts with a central database;

FIG. 19 is a data flow diagrams illustrating how a transaction based credit transfer procedure interacts with a central database;

FIG. 20 is a data flow diagrams illustrating how a credit redistribution procedure interacts with a central database;

FIGS. 21, 22, 23, 24 show exemplary definitions of databases comprised in the central database and tables thereof;

FIG. 25 is a data flow diagram showing the steps of a transaction based credit transfer procedure.

### DESCRIPTION OF THE PREFERRED EMBODIMENTS

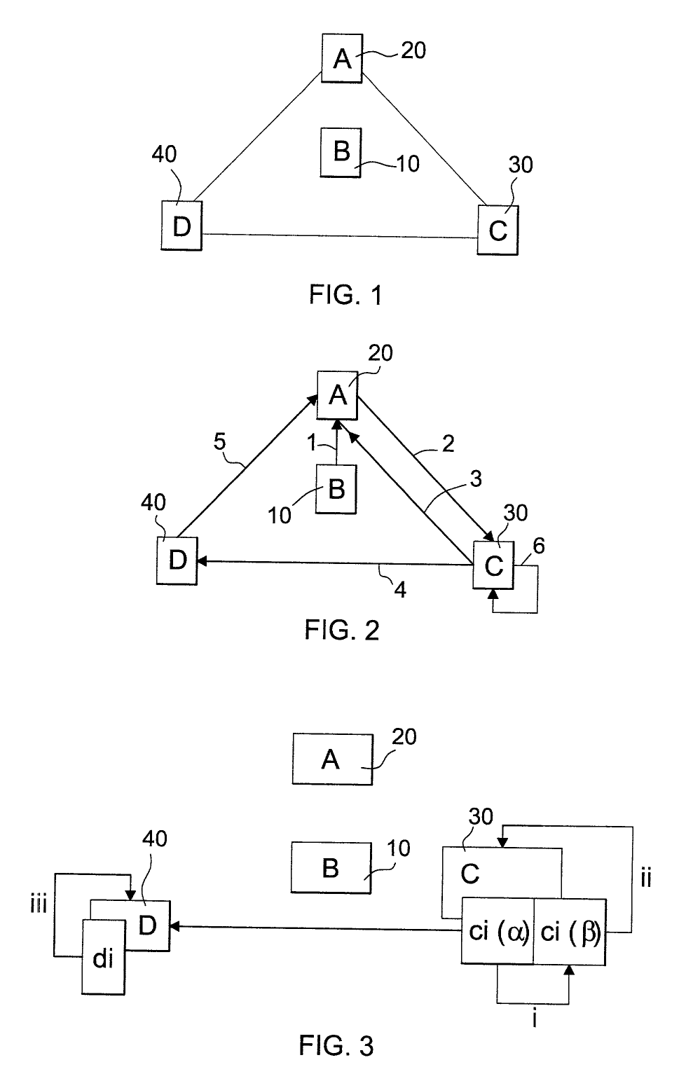

FIG. 1 is an exemplary view illustrating the actors involved in the application of the new method and system according to the present disclosure.

Particularly, the system comprises a clearing center 10, and participants or members 20, 30, 40.

Participants are grouped into three different categories, according to which they play a different role in the system, carry out different operations and benefit from the invention as claimed in a different way.

The first category, which will be hereafter referred to as “merchants” 20, comprises any business, firm, company, individual or other entity able to issue credits to another participant, usually, but non exclusively, on purchase or exchange of goods or services.

The second category, which will be hereafter referred to as “consumers” or “customers” 30, comprises any business, firm, company, individual or other entity allowed to receive credits from any of the members belonging to the above described first category; for example, a customer receiving credits as loyalty points or discount bonuses, on purchase of goods or services, or an employee receiving credits as a bonus voucher or incentive, adding to his regular wage.

The third category, which will be hereafter referred to as “nonprofit organizations” 40 comprises any association, foundation, public corporation or other organization or group or branch, allowed to receive decumulated credits from any participant belonging to the above described second category.

It is to be noted that a member of a category may well belong to one or more of the other categories. Most noticeably, a nonprofit organization 40 is likely to be or to act as a consumer 30, so as it may occur for a merchant 20.

Moreover, a merchant 20 may also be an associate member of the clearing center 10 or the clearing center 10 itself.

The skilled in the art will therefore appreciate that, in the present disclosure, a partition in three categories 20, 30, 40, plus the clearing center 10, is given only for clarity reasons and shall not be seen as a limitation to the teachings of the invention.

Each participant is entitled to one or more accounts, which may be of different types, hereby identified by different Greek letters. Particularly, the credits available in the program are of two basic types, according to the corresponding account type to which they belong. Therefore, the credits held in a consumer's account of type α are referred to as “credits α”, while the credits held in a consumer's account of type β will be referred to as “credits β”.

In this embodiment, the decumulation process does not apply to merchants nor to nonprofit organizations. The participants in both of these categories, therefore, hold accounts of just one type, giving no need to distinguish between credits and when referring to them.

Referring now to FIG. 2, six kinds of operations can be performed between participants within the circuit: transfer of credits from the clearing center 10 to a merchant 20 (arrow no. 1); transfer of credits from a merchant 20 to a consumer 30 (arrow no. 2); redemption of credits α by a consumer 30 from a merchant 20 (arrow no. 3); donation of credits by a consumer 30 to a nonprofit organization 40 (arrow no. 4); redemption of credits by a nonprofit organization 40 from a merchant 20 (arrow no. 5); transfer of credits α and/or β from a consumer 30 to a second consumer 30 (arrow no. 6).

Further key operations, which originate from the inventive concept underlying the present invention, are shown in FIG. 3 and include decumulation of credits from an account of type α of a consumer 30 to an account of type β of the same consumer 30 (arrow “i”); redistribution of credits from an account of type β of a consumer 30 to a number of accounts β of other consumers 30 (arrow “ii”); redistribution of credits from a nonprofit organization 40 to a number of other nonprofit organizations 40 (arrow “iii”). Decumulation and redistribution are the two forms of automatic transfer, within this embodiment of the invention. The terms “decumulation” or “decumulating” hereby indicate the operation of automatically reducing the account of a participant by a certain amount according to a time-based algorithm and to cancel such amount or to assign such amount to a different account, owned by the same participant. The term “redistribution” indicates the operation of automatically transferring stagnating credits from an account of a participant to a plurality of other participants. Both forms of automatic transfer are designed to prevent the stagnation of credits and, therefore, to allow a balanced multilateral program, in which all participants are in direct relation, and credits tend to be assigned to the participants more inclined to spend them.

Acquisition of Credits by a Merchant

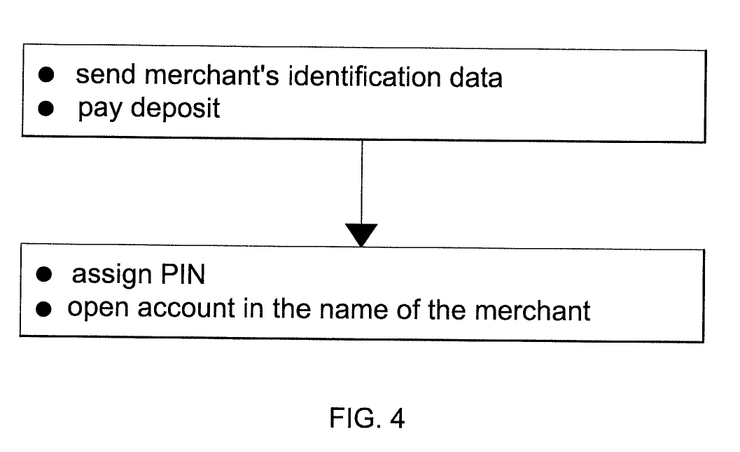

The steps of acquiring credits by a merchant 20 are briefly depicted in FIG. 4. A merchant 20 sets forth to the clearing center or account manager 10 a request to receive a desired amount of credits. To this purpose, he provides the account manager with identification data and pays a deposit as set by the clearing center 10.

The clearing center 10 records identification data of the merchant 20 into the merchant database, assigns a PIN (personal identification number) to the merchant 20, and opens an account in the name of the merchant.

Issuing Credits by a Merchant

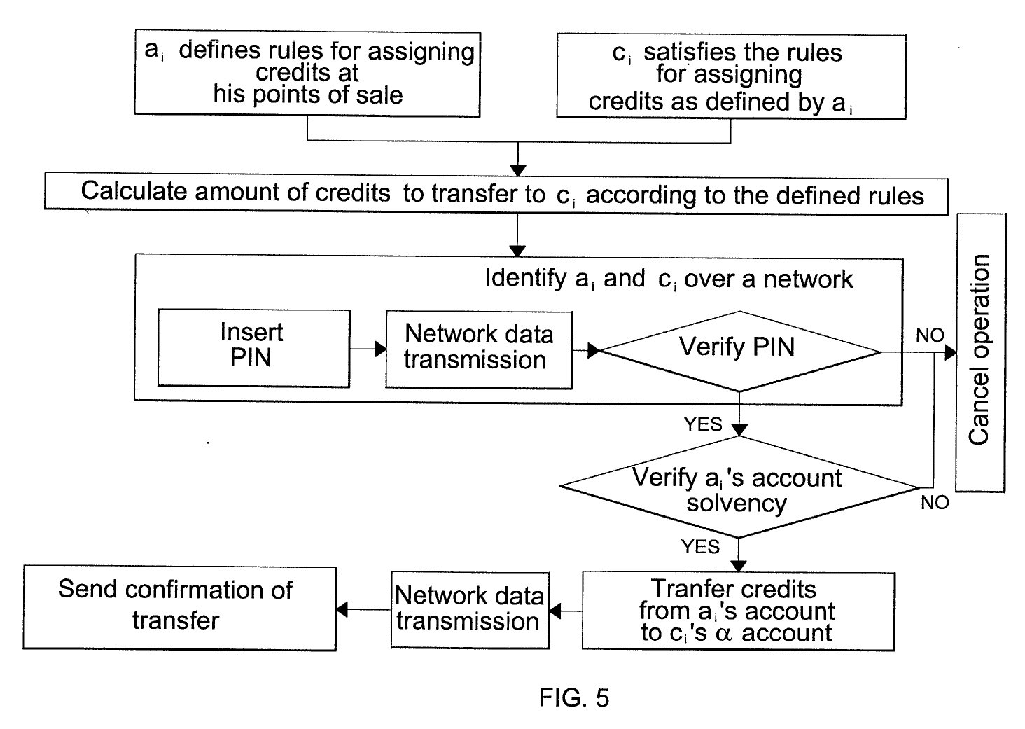

With regard to FIG. 5, a merchant 20 defines his own criterions or rules according to which credits are assigned to customers shopping at his points of sale, typically for the purchase of goods or services.

In the case that a consumer 30 satisfies such criterions or rules, a calculation is performed to determine the number of credits that shall be assigned to the account of type α of the consumer. The calculation is preferably carried out in an electronic way by electronic means, for example when the goods or services purchased by the customer are entered for the computation of the total due amount, as widely known in the state of the art.

The consumer may be identified by any of the traditional means used for such purpose, for instance by a customer card, a cash card or the like, provided with a barcode to be scanned by a barcode reader, a magnetic strip holding a customer's identity, a unique number to be typed in by the cashier or vendor.

It shall be appreciated that it is not even strictly necessary to provide consumers with new cards, in that, according to an embodiment of the invention, a credit or debit card may serve the same purpose.

At the time a transaction is ready for submission, data identifying the merchant 20, data identifying the customer 30 and data defining the amount of credits that should be issued by the merchant 20 and awarded to the customer 30 are sent to the clearing center 10. The merchant and the customer may both be required to enter a PIN code assigned by the clearing center and/or by the card issuer to authorize the credit transfer.

Normally, the merchant 20 will enter his code into a terminal only once at the opening of the day, while a customer will be required to enter his PIN code each time a transaction is required.

On receiving of the data sent by a merchant's point of sale, the clearing center 10 checks for the merchant's availability of credits, and, should the outcome be positive, transfers the required number of credits from the merchant's account to the consumer's account of type α. Finally, it sends an electronic message over the network to the merchant's apparatus, confirming the transfer. Otherwise, a failure message is sent back to merchant's apparatus and no credit transfer occurs.

If a secure encryption system is adopted, as widely known in the state of the art, the credits must not even be registered at a central database. All or part of the credits may be stored in a peripheral device such as a server (typically for the merchants' credits) or a personal computer or smart card (typically for the consumers' credits). In this case, the identification of the customer (and the merchant), the calculation of the credits to which the customer is entitled and the electronic credit transfer are all performed by a peripheral processor.

It is worth noting that credits may be issued by merchants in a variety of manners and for a variety of reasons. For instance, merchants may include, inside or on a product boxing, a card provided with a hidden code readable through scratch off, rub off or wash off techniques and corresponding to a certain amount of credits. The consumer may then use a phone, a mobile, a personal computer or any other device that may connect him to a computer server of the clearing center and enter his PIN code and the code of the card in order to have the credits assigned to his account.

Decumulation of Credits α into Credits β

As now clear, one of the key aspects of the present invention is its ability to avoid stagnation of credits on participants' accounts. A first key step used to achieve this aim is to force the decumulation of a portion of the credits α owned by a consumer 30 to credits β, owned by the same consumer 30.

Credits β may not be redeemed by a consumer 30 against the purchase of goods or services, but may be donated to nonprofit organizations 40, which are instead allowed to use them as if they were consumers' credits α.

The decumulation process is always triggered by a transaction of any kind in which a consumer is involved.

The decumulus of credits α into credits β may be achieved according to any appropriate algorithm. In a preferred embodiment, the algorithm used for switching credits α into credits β comprises the steps of: reading the balance “s” of a consumer's account α; reading the balance “d” of the consumer's account β; computing the number “n” of days elapsed since the last operation of the consumer on either of his accounts; calculating the decumulus “k” on a daily decumulus rate “i” basis, according to the expression k=s_{old}−(1−i)ⁿ*s_{old}; transferring the amount of credits resulting from this computation from the account a to the account β.

Redeeming Credits α

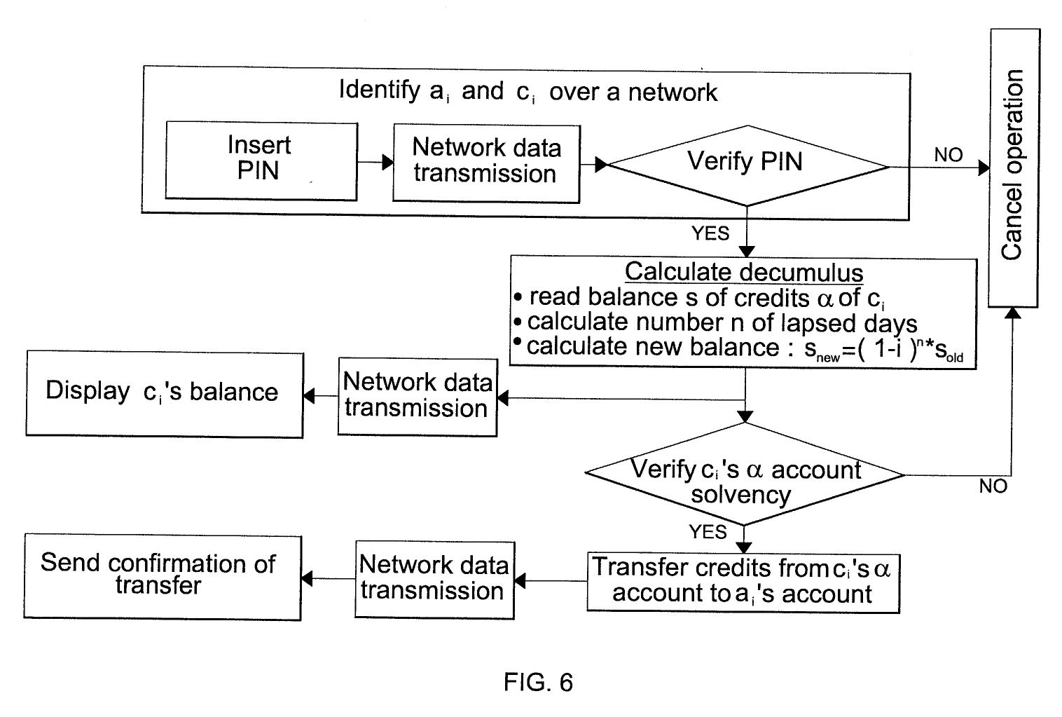

Referring to FIG. 6, a consumer 30 may now wish to use some or all of the credits assigned to his account α to obtain discounts or cover part or all of the costs of a new purchase made at a shop or point of sale of an authorized merchant 20 participating in the program.

Supposing now that the merchant 20 has already entered in the system his id data and/or PIN code, as explained in the previous section, the consumer 30 enters his PIN code to confirm the request. This data, together with data relating to the amount of credits he should spend for the purchase, is transferred to the clearing center 10.

Before the transaction takes place, a decumulation process is carried out, consisting in the steps of: reading the balance of the consumer's account α as concerns the amount of credits α available to the consumer 30; applying a decumulation algorithm; and calculating a new balance.

In a preferred embodiment, the calculation of the new balance is given by the expression: s_{new}=(1−i)ⁿ*s_{old}, wherein “i” is a daily decumulus rate and “n” is the number of days elapsed since the last operation was made by the consumer on either of his accounts.

The new balance s_{new} is then sent back to the merchant's terminal apparatus and shown thereon.

The clearing center 10 now verifies whether the new customer's balance is able to supply the amount of credits α necessary to obtain the desired discount or credit redemption.

Should the outcome of this be positive, the necessary amount of credits is transferred from the consumer's account α to the merchant's account and an electronic message is sent over the network to the merchant's terminal apparatus, confirming the transfer. Otherwise, a failure message is sent back to merchant's apparatus and no credit transfer occurs.

In a possible embodiment making use of smart cards, as previously suggested, all operations described may be performed peripherally.

Donation of Credits

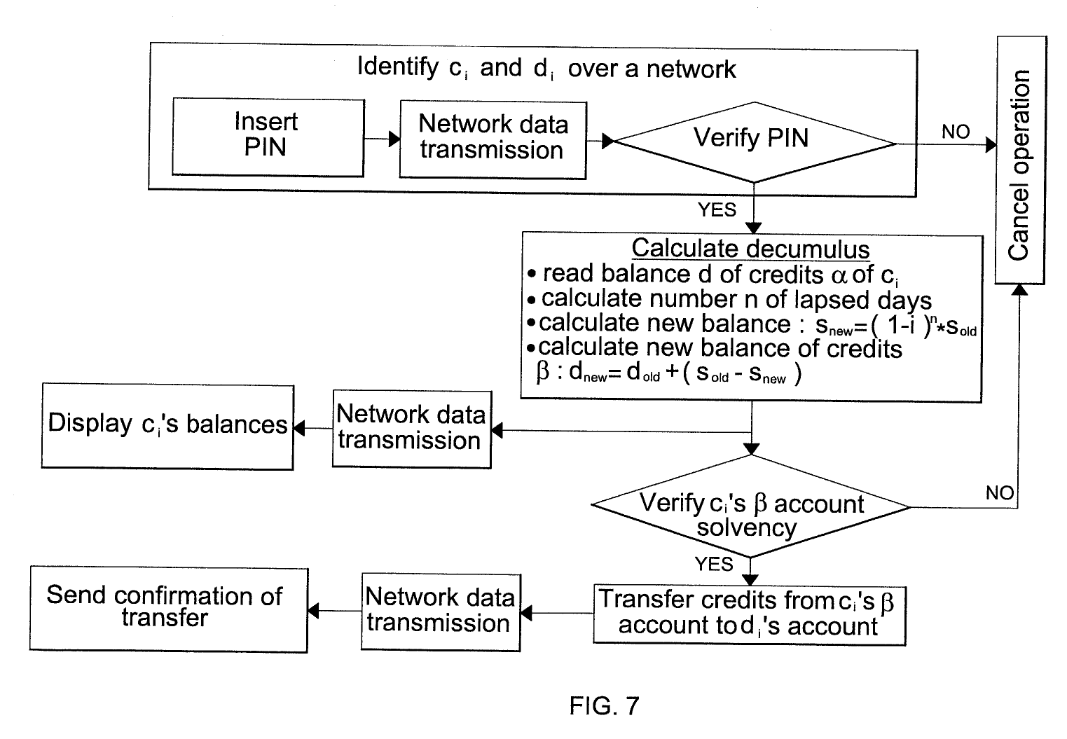

Referring now to FIG. 7, credits β may not be used by a consumer 30 to buy goods or services, but may be donated to nonprofit organizations enrolled in the program.

When a consumer wishes to donate some or all of the credits contained in his account β, decumulated from his account α, to one of the nonprofit organizations 40 participating in the program, he goes to or gets in touch with the chosen nonprofit organization, for example through the internet site of the organization or by means of a terminal connected to a telecommunications network.

The consumer 30 and the nonprofit organization 40 are required to enter their respective PIN codes and/or identification data into an electronic terminal connected with the clearing center 10, such data is sent to the clearing center over a network, such as the Internet, together with the amount of credits that the consumer 30 wishes to donate.

The clearing center 10 verifies the id of the consumer and of the nonprofit organization.

A decumulation process is then carried out, consisting in the steps of: reading the balance of the consumer's account α; applying a decumulation algorithm; and transferring the resulting decumulus from the account α to the account β.

In a preferred embodiment, the calculation of the decumulus is given by the expression: k=s_{old}−(1−i)ⁿ*s_{old}, wherein “i” is a daily decumulus rate and “n” is the number of days elapsed since the last operation on credits was made by the consumer on either of his accounts.

The new balance is then sent back to the terminal and shown thereon.

The clearing center 10 now verifies whether the new customer's balance β is able to supply the amount of credits β the customer wishes to donate and, if so, transfers an amount of credits from the consumer's account to the nonprofit organization's account. An electronic message is sent over the network to the terminal used for the operation, either confirming the transfer or notifying a failure.

Redeeming Credits by a Nonprofit Organization

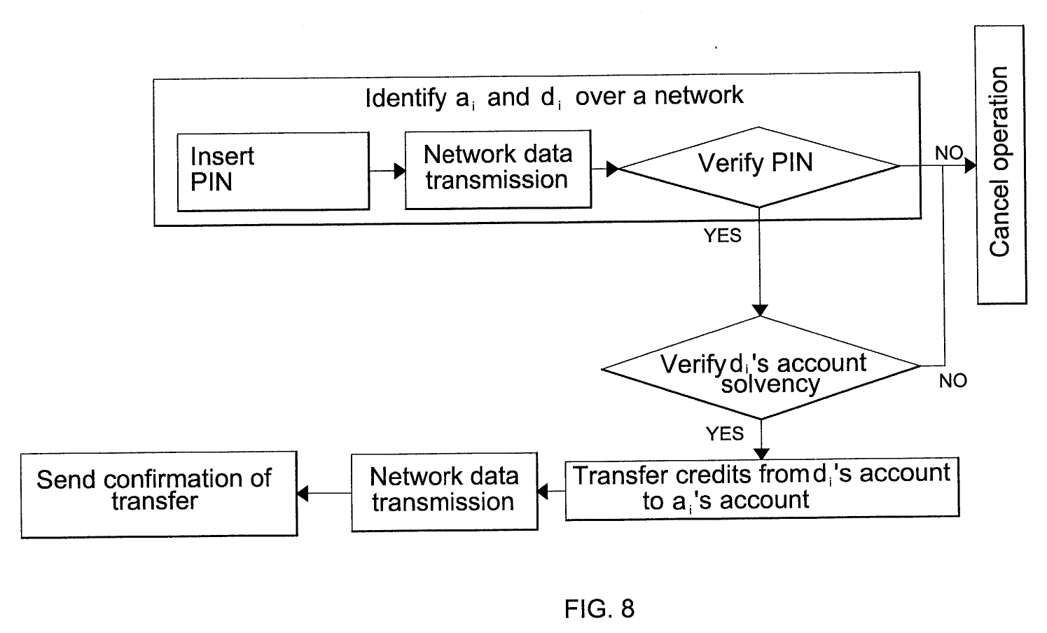

As shown in FIG. 8, a nonprofit organization 40 may redeem some or all of the credits accumulated on its account to obtain discounts or cover part or all of the costs of a purchase made at a shop or point of sale of an authorized merchant 20 participating in the program.

Supposing, again, that the merchant 20 has already entered in the system his id data and/or PIN code, as already explained with regard to FIG. 6, the nonprofit organization 40 enters its PIN code to confirm the request of redeeming some or all of its credits.

This data, together with data relating to the amount of money required for the purchased goods or services and the amount of credits the nonprofit organization needs to carry out the purchase, is transferred to the clearing center 10.

The clearing center 10 verifies the id of the nonprofit organization 40 and the id of the merchant 20, and checks for the availability of credits on the nonprofit organization's account.

Should the outcome be positive, the required amount of credits is transferred from the nonprofit organization's account to the merchant's account and an electronic message is sent over the network to the merchant's apparatus, confirming the transfer. Otherwise, a failure message is sent back to merchant's apparatus and no credit transfer occurs.

Transfer of Credits from a First Consumer's Account to a Second Consumer's Account

Chances exist that either a consumer 20 has more than an account or that he may wish to transfer part of his credits to an account of another consumer, either for putting together a larger amount of credits on a same account to achieve redemption schemes that require a significant amount of credits, to merge his credits with the ones owned by a next of kin or even to make a gift to a third consumer.

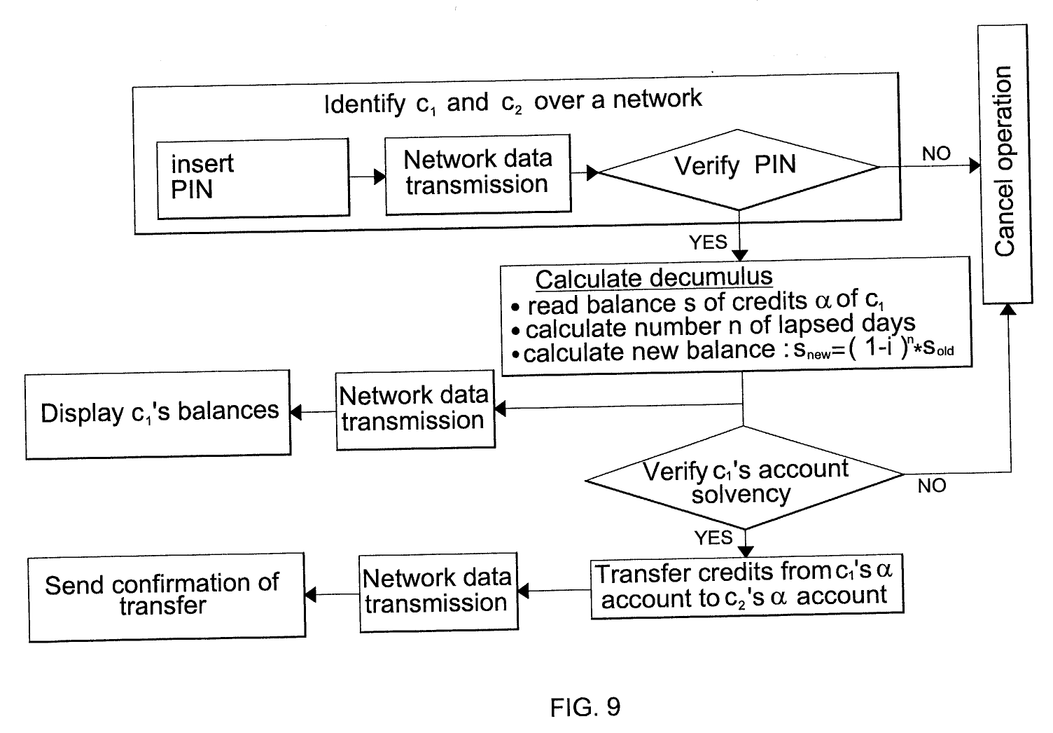

The steps through which such transfer is made possible are shown in FIG. 9. In this case, both customers must identify themselves over a network, for instance the Internet, a WAP network or a PSTN (public switched telephone network). In any of the mentioned cases, automatic recognition of the consumers involved in the transfer does not require human intervention, in that it can be fully carried out in automatic ways according to traditional methodologies known in the art, which will not be described in detail.

For instance, the consumers may connect to an Internet site managed by the clearing center or account manager 10, activate a transfer procedure and follow the steps indicated on screen by a traditional computer application running on the account manager's server. The same applies in the case of a WAP connection. As regards, the PSTN, the consumers may dial a phone number provided by the account manager 10, follow recorded voice instructions and use the phone keyboard to generate tones indicating numbers and choices.

Whatever method is chosen, the clearing center 10 will perform the steps of: reading the balance of the first consumer's account, applying a decumulation algorithm and calculating a new balance.

In a preferred embodiment, the calculation of the new balance, s_{new}, is given by the expression: (1−i)ⁿ*s_{old}, wherein “i” is a daily decumulus rate, “n” is the number of days elapsed since the last operation on either account and “s_{old}” indicates the old account balance.

The clearing center 10 now verifies whether the first consumer's new balance is able to supply the amount of credits he wishes to transfer to the second consumer's account of corresponding type. If so, the transfer is actually carried out and a message is sent back to the consumers, notifying the positive outcome of the operation and the respective balances.

Otherwise, a failure message is sent back to the terminal used by the consumers and no credit transfer occurs.

Such peer to peer credit transfers may also be performed between accounts of two nonprofit organizations or two merchants, for example for the payment of purchases B2B.

Redistribution of Consumers' Credits β

As previously shown with referral to FIG. 7, a consumer 30 may spend or donate his credits β to any nonprofit organization of his own choice. However, in order to avoid the stagnation of credits β, a redistribution of stagnating credits β is performed on a regular basis.

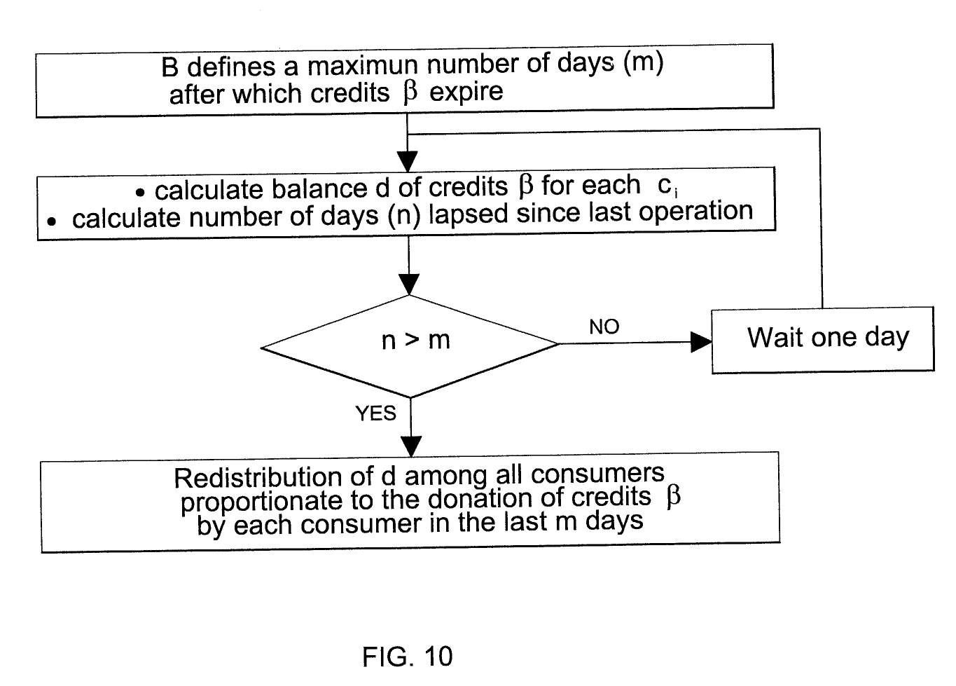

Particularly, with regard to FIG. 10, the clearing center or account manager 10 defines a time “m” after which also the credits owned by consumers 30 expire.

A balance “d” of credits is then computed for each consumer 30, and the number “n” of days lapsed since the last operation was made is checked.

Should “n” be less than “m”, the account is disregarded.

Otherwise, the credits β of the consumer, or a portion thereof, are shared out to all other consumers in proportion to the total donation of credits β made by each consumer in the last period of “m” days.

Redistribution of Nonprofit Organizations' Credits

The same applies to credits owned by nonprofit organizations.

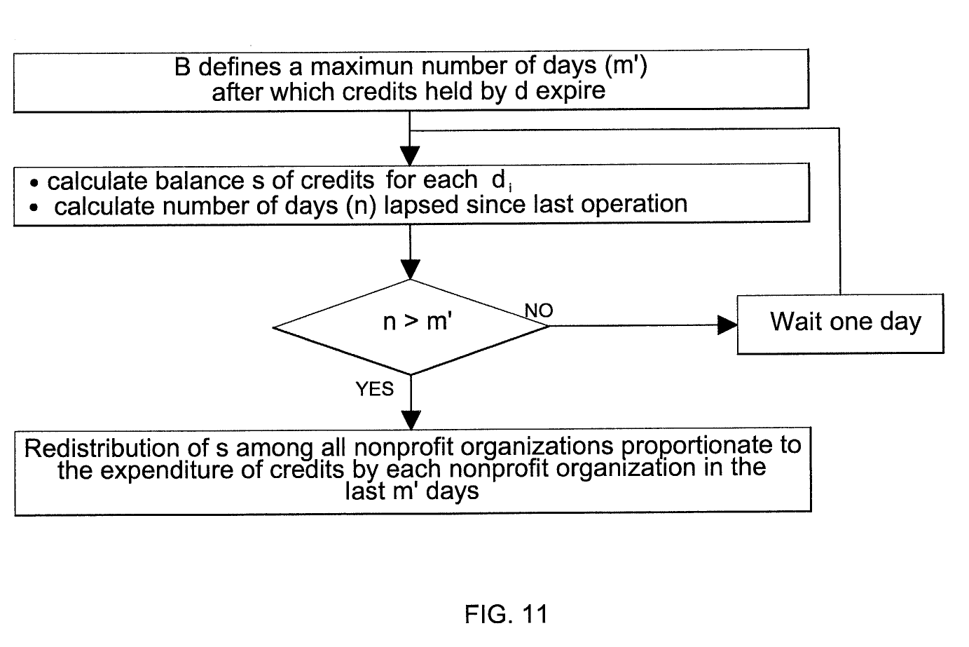

Particularly, with regard to FIG. 11, the clearing center or account manager 10 defines a second time “m′” after which the credits owned by nonprofit organizations 40 expire.

The balance “s′” of credits is then retrieved for each nonprofit organization 40, and the number “n” of days lapsed since the last operation was made is checked.

Should “n” be less than “m′”, the account is disregarded.

Otherwise, the credits of the nonprofit organization, or a portion thereof, are shared out to all other nonprofit organizations proportionate to the total expenditure of credits made by each nonprofit organization in the last period of “m′” days.

It is to be noted that the periodical decumulation of credits α into credits β and the redistribution of β credits belonging to consumers 30 or of credits belonging to nonprofit organizations 40 may be implemented in several ways, each of which is embraced in the inventive concept underlying the present invention.

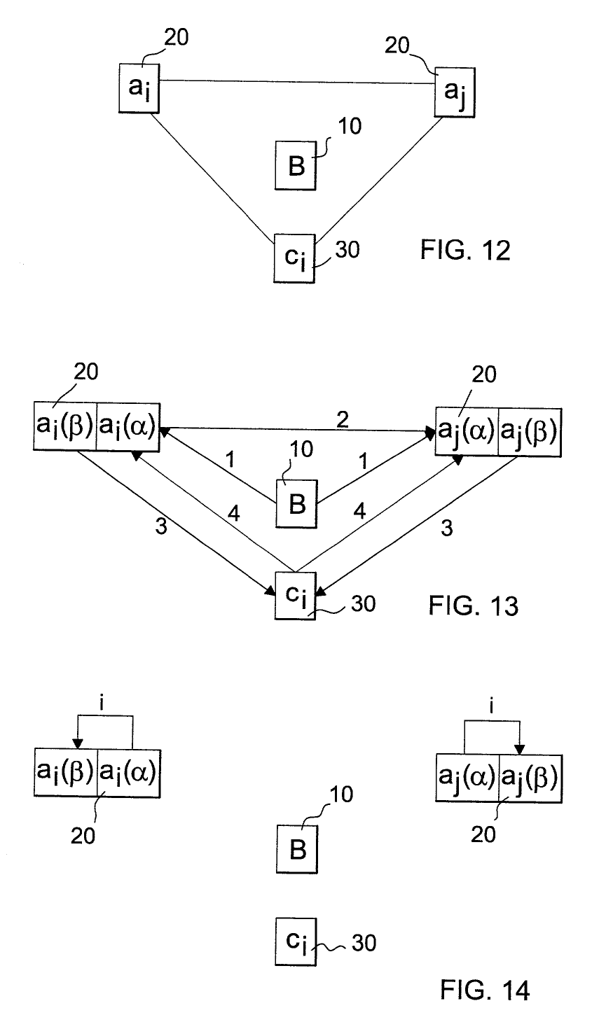

A second embodiment of the present invention comprises a clearing center and two categories of participants: merchants 20 and consumers 30 (as shown in FIG. 12). In this embodiment, each merchant 20 is entitled by the clearing center 10 to issue a certain amount of credits. Such credits can be used by each merchant 20 to pay any other merchant 20 in the circuit for the payment of supplies (B2B). The credits owned by each merchant 20 are decumulated according to a time-based algorithm, and hence transferred from the first account ( ) to a second account ( ) entitled to the same merchant 20 (FIG. 14). The credits of the -accounts cannot be used for payments to other merchants 20; instead they can be used exclusively for payments to consumers 30, e.g. for promotions to customers or for wage bonuses to employees. The credits earned by the consumers 30 can then be spent to purchase goods or services from any merchant 20 of the circuit. The credits earned by a merchant 20 from the consumers 30 are credited to his -account, and therefore return into the circuit of B2B payments, until further decumulation (FIG. 13). The decumulation here measures the depression of B2B payments, and therefore the need for sales promotions, providing immediately the means for such promotions in a proportionate measure.

Particularly, the skilled in the art appreciates that clearing center 10 may be provided with a technical system comprising hardware and software means which cooperate for the implementation of the disclosed method.

The preferred embodiment of the system according to the present invention, which will be now described, shall therefore not be considered as limiting the scope of protection of the present invention.

The clearing center or account manager 10 is provided with computer means for performing computations on data stored in a dedicated database, which holds the id codes and data of the members enrolled in the system. Moreover, the system is provided with a middleware for managing and tracking data exchanged over a network which connects participants to the system, as known in the state of the art. The system may be implemented either for on-line and off-line operation.

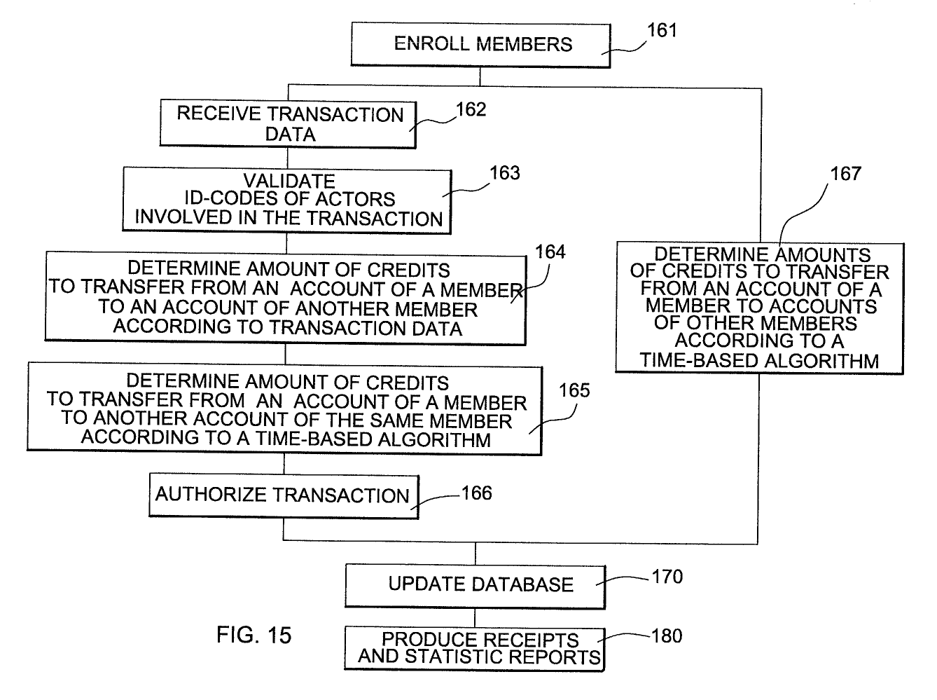

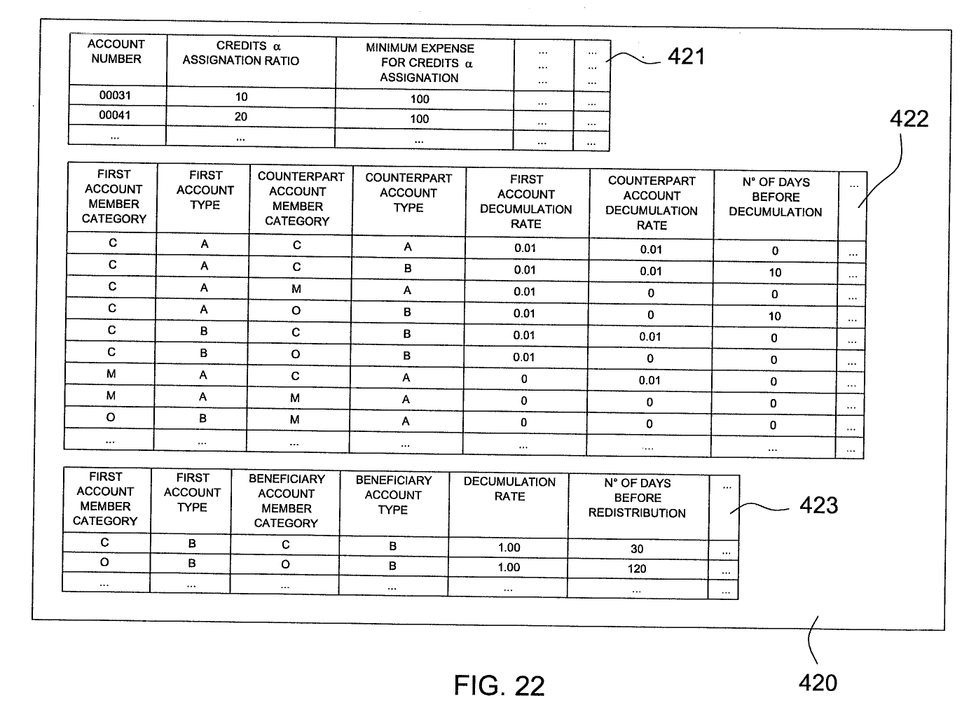

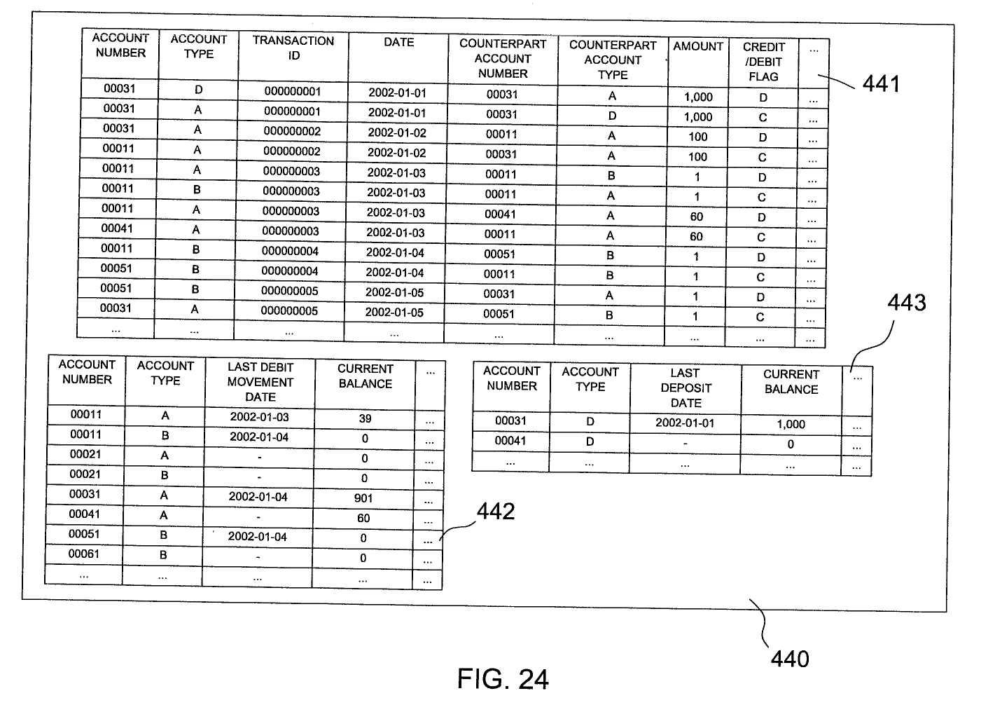

The characterizing features of the system according to the present invention, and the hardware and software components implementing the features thereof, will be now described with regard to FIGS. 15 to 25.

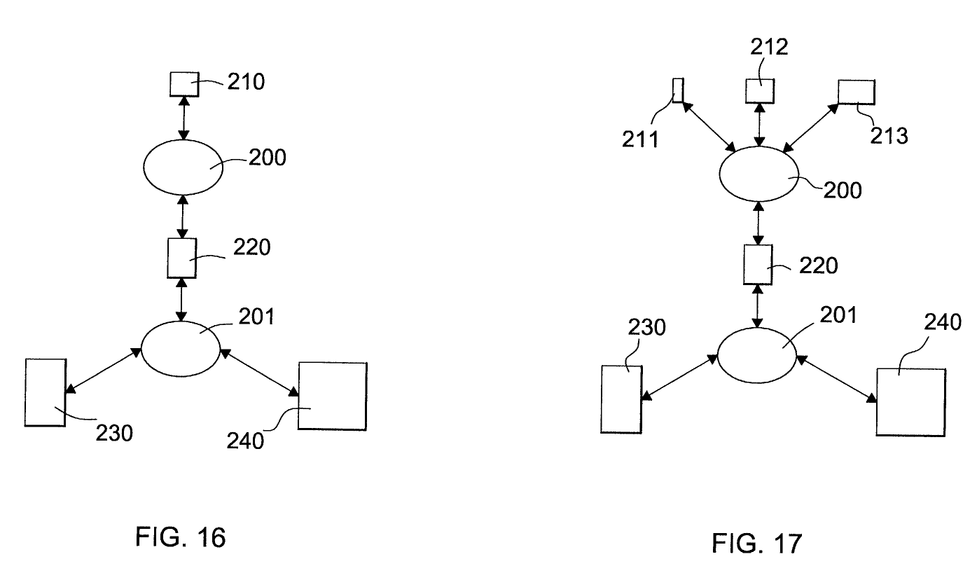

FIGS. 16 and 17 illustrate a network based system showing networks 200-201, terminal means 210, 211, 212, 213, a server 220, a clearing center host 230 and a payments authorization system (PAS) 240.

In the former case, the preferred device used for entering transaction data and displaying notification messages is a POS terminal 210, and the network 200 is a dedicated network of the POS circuit.

In the other case, a mobile phone 211, a personal computer 212, an Internet TV apparatus 213 or any other programmable device maybe used, and the network 200 connecting the terminal to the server is typically the Internet network or a hybrid combination of wireless and Internet networks connected through a gateway. Moreover, the server 220 comprises means for simulating a virtual POS, so as to maintain consistency when data is transferred from and to the clearing center host 230 and the PAS 240.

The server 220 comprises traditional communication means for exchanging information with terminal means 210 and the PAS 240.

The server 220 further comprises communication means for exchanging information with the clearing center host 230, preferably in the form of a software application connected to the clearing center host through a secure or dedicated communication channel.

All the information and data required to activate transactions, store participants' data and define decumulation rules, are stored in a central database 400.

The central database 400 comprises four main databases: the Members database 410, the Credit-Transfer Rules database 420, the Transaction database 430 and the Account database 440.

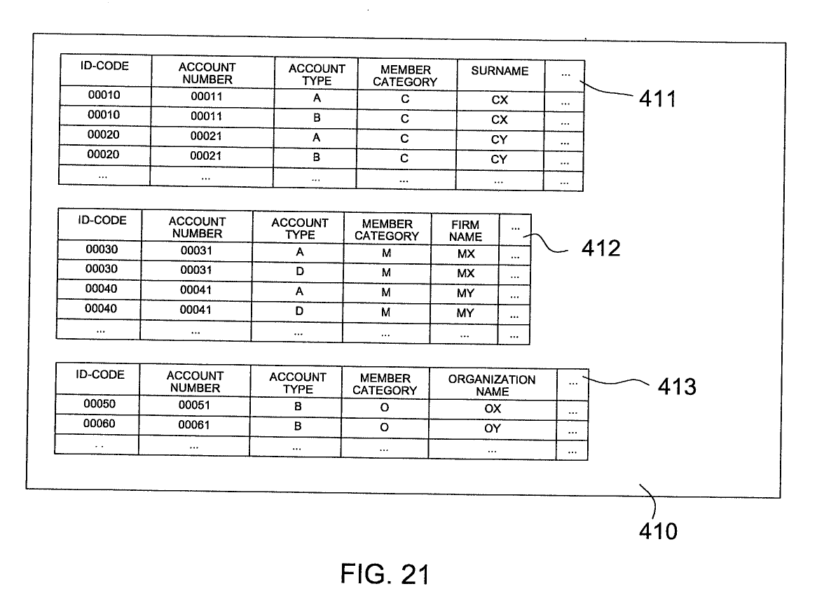

FIGS. 21 to 24 show some records and illustrate a preferred structure of these databases. The fields shown are limited to the core data used to exploit the system: minor or detail fields are not shown, and are indicated in the drawings with a “-” symbol.

The Members database holds data concerning the participating members and a category to which they are assigned. In the exemplary embodiment hereby described, a member may belong to one of three categories, identified as “Customers”, “Merchants” and “NonProfit”.

The Members database 410 comprises a number of databases equal to the number of categories as above identified: in this specific case, it comprises three databases: the Consumers database 411, the Merchants database 412 and the Nonprofit database 413.

Of course, the databases are distinguished on a logical level, not necessarily on the physical one.

The three databases share the first four fields: ID-CODE, ACCOUNT NUMBER, ACCOUNT TYPE and MEMBER CATEGORY. Further fields may vary according to category in issue.

The first field, ID-CODE, is a key field used to identify the participant throughout the system, and must be unique to each participant.

The ACCOUNT NUMBER and ACCOUNT TYPE are key fields identifying an account of the participant. Different codes are used to identify different account types. For instance, “A” indicates accounts of type A, “B” indicates accounts of type “B”, and “D” indicates monetary deposit accounts.

The MEMBER CATEGORY field indicates the category to which the participant belongs: in this case, “C” stands for “consumer”, “M” for “merchant” and “O” for “nonprofit organization”.

The Credit-Transfer Rules database 420 holds the rules that shall be applied to perform calculations when credit transfer occurs between two participants.

In a preferred embodiment, the database 420 comprises at least three sets of rules, logically spread onto three databases: the Merchant rules database 421, which determines the amount of credits to be transferred from a merchant's account to a consumer's account in exchange of goods or services and the minimum consumer's expenditure necessary to trigger the credit transfer, a Credit Decumulation Rules database 422 which determines decumulation rates depending on the categories to which the involved participants belong and the number of days after which a decumulation is automatically performed, and a the Credit Redistribution Rules database 423, which is structured in a similar way and concerns automatic redistribution of credits, most usually with regard to accounts of “B” type, after a certain period of time.

The Transaction database 430 keeps record of all transactions that occur in the system.

The database 430 is mainly provided with eight field:

a TRANSACTION ID, which is a unique progressive code identifying the transaction;

a DATE, which is a date stamp of the day the transaction occurred;

an ACCOUNT NUMBER and ACCOUNT TYPE, which identify the account and type of account of the first participant involved in the transaction;

a COUNTERPART ACCOUNT NUMBER and a COUNTERPART ACCOUNT TYPE which identify the account and type of account of the second participant involved in the transaction;

the AMOUNT of credits or money transferred, according to the aforementioned account types;

an AMOUNT OF TRIGGERED DECUMULATION, which keeps track of the contextual decumulation made on the COUNTERPART ACCOUNT when the credit transfer occurred.

Finally, the account database 440 comprises three databases: the Account Movement database 441, the Account Balance database 442 and the Deposit database 443.

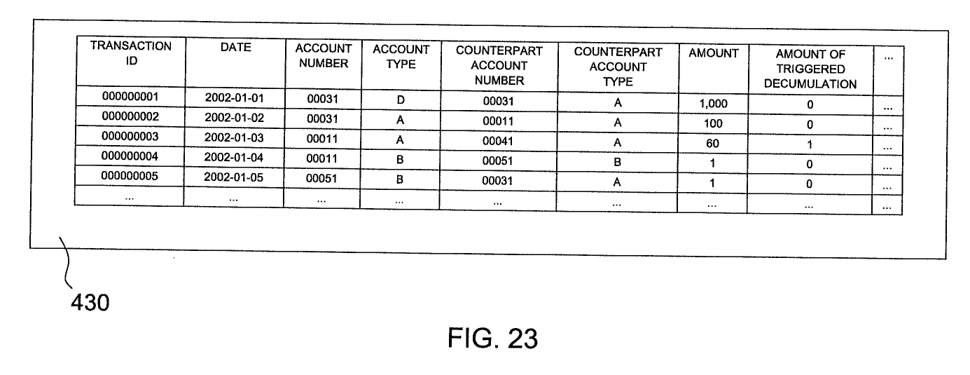

The Account Movement database 441 comprises at least eight fields as defined in FIG. 23. The meaning of such fields is the same as already explained with regard to the Transaction database 431. Furthermore, a CREDIT/DEBIT FLAG field is defined, indicating whether the movement of credits and/or money recorded on the account was a debit “D” or a credit “C” operation.

The Account Balance database 442 indicates the amount of credits available on a certain account of either type “A” or “B” and the date of the last movement which led to the indicated amount (CURRENT BALANCE and LAST DEBIT MOVEMENT fields).

The Deposit database 443 stores the same information as the Account database 442, this time with respect to monetary accounts “D”.

Three main procedures 310, 311, 312 generate events and change the contents of the above databases.

A procedure hereby identifies a number of steps, triggered by user's action and performed by a software application, or engine, which involve updating records in the database or fetching information therefrom.

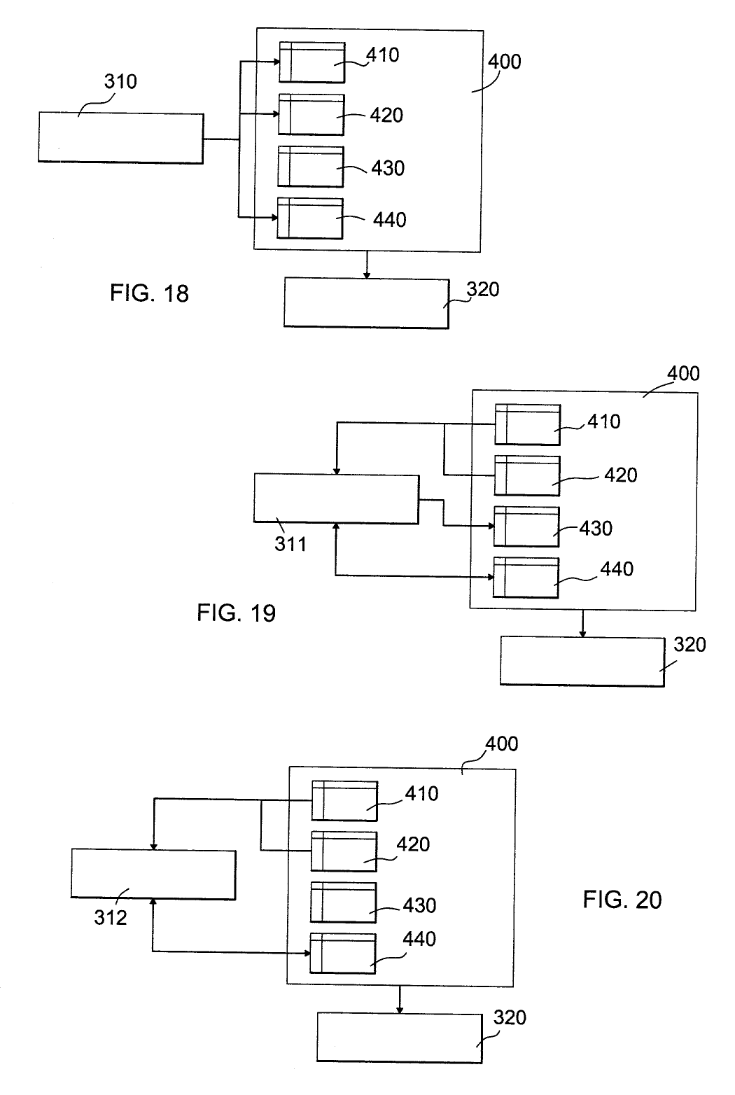

FIG. 18 illustrates the Enrollment and Customization Procedure 310, which add records to the Members database 410, the Credit Transfer Rules database and the Account database, in order to enter a new participant in the systems, define the credit transfer rules to be applied when a transfer occurs from one of his accounts to the account of a different member and store the status and movements pertaining his accounts.

FIG. 19 illustrates the Transaction-Based Credits Transfer procedure 311, which fetches information from the Members and Credit Transfer Rules databases 410, 420 and add records to the Transaction and Account databases 430, 440 to store transaction data and update participants' accounts each time a transaction occurs.

FIG. 20 illustrates the Credits Redistribution procedure 312, which fetches information from the Members and Credit Transfer Rules databases 410, 420 and updates the Account database 440.

FIG. 15 clarifies the main actions carried out by the system. The starting step 161 regards enrolling members into the system.

Two main branches may then be followed during operation. The first branch applies to transactions occurring between participants. When a transaction is started, the system receives transaction data (step 162), validates the ID-CODES of the participants involved in the transaction (step 163), determines the amount of credits to be transferred form an account of the first participant to an account of the second participant (step 164), determines the amount of credits to be transferred from an account of either participant to another account of the same participant according to a time based algorithm or rules (step 165) and authorizes or denies the transaction (step 166).

The second branch is triggered automatically on a periodical basis, and determines the amount of credits to be transferred from an account of a participant to accounts of other participants according to a time based algorithm or rules (step 167).

Eventually, the system database is updated (step 170) and a reporting procedure is optionally activated (step 180).

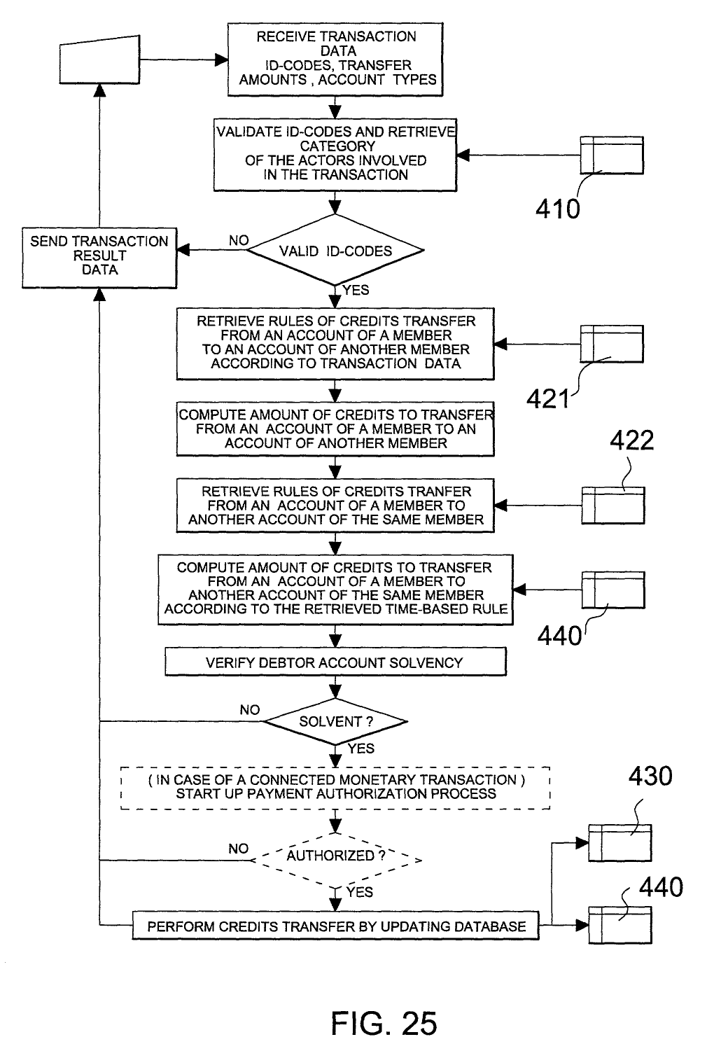

A detailed explanation of the Transaction Based Credit Transfer procedure is now described in referral of FIG. 25 and by means of an illustrative example, to better clarify the way the system works and how the application engine works.

In this text, the term “transaction” refers to a generic transaction involving some kind of credit transfer between participants to the program, while the expression “monetary transaction” refers to operations involving a money transfer in exchange of goods or services. For the sake of simplicity, it is hereby assumed as a hypothesis that one credit point corresponds to one dollar.

A consumer named “CX”, enrolled in the program, wishes to purchase some goods worth 1,000 dollars at a point of sale of a participating merchant, named “MX”. The payment occurs through a POS terminal located at the merchant's point of sale. The consumer hands over his credit card to the merchant, which card is provided with a microchip and/or a magnetic strip either containing his ID-CODE or data through which the system is able to recover the participant's ID-CODE. The merchant's ID-CODE is embedded in the POS itself, either hard coded or entered by a merchant at the opening of the day.

The merchant types in the amount due by the consumer for the purchased goods and a functional code which allows to identify the kind of transaction to be carried out within the circuit. In this case, the transaction includes a transfer of credits from an account A of the merchant to an account A of the consumer, as a discount on the sale price. The consumer uses the terminal to enter his id code.

The POS terminal transfers the data concerning both the monetary and the credit transaction to the server 220, which manages the POS network. The server 220 (or another one connected to it) freezes the monetary transaction authorization process, binding it to the outcome of the credit transaction.

Particularly, the server 220 sends the following data to the clearing center host 230 through network 201:

FIRST ID-CODE=‘00030’;

FIRST ACCOUNT TYPE=‘A’;

COUNTERPART ID-CODE=‘00010’;

COUNTERPART ACCOUNT TYPE=‘A’;

AMOUNT OF MONETARY TRANSACTION=‘1,000’.

Upon receiving this data, the Transaction Based Credit Transfer procedure 311 is activated on the clearing center host.

The system accesses to the Members database 410 and verifies that the participants, merchant and consumer, be actually enrolled in the system by checking the received ID codes. The system then checks that the participants are entitled to perform the required transaction, and retrieves their respective account numbers and the category to which they belong.

ID-CODE=‘00030’ & ACCOUNT TYPE=‘A’→ACCOUNT NUMBER=‘00031’ & MEMBER CATEGORY=‘M’

ID-CODE=‘00010’ & ACCOUNT TYPE=‘A’→ACCOUNT NUMBER=‘00011’ & MEMBER CATEGORY=‘C’.

The association between ID-CODE and ACCOUNT-NUMBER is hereby described, for illustrative purposes, with regard to a very simple implementation. Of course, such implementation may be carried out through complex data security systems, based, for instance, on cryptography algorithms.

In the case that one or both of the participants were not found in the Members database or not allowed to the requested type of transaction, the system sends out a negative outcome to the server 220, which in turn cancels the monetary transaction. A message indicating the negative outcome is also sent to the POS terminal and displayed thereon.

On the contrary, should both ID-CODES be found in the Members database, the system queries the Merchants Rules Database, in order to verify the applicability of the discount and determine an amount thereof. For instance, the following rule is encountered:

ACCOUNT NUMBER=‘00031’→CREDIT A ASSIGNATION RATIO=‘10’ & MINIMUM EXPENSE FOR ASSIGNATION=‘100’.

The system applies the retrieved rule and computes the amount of credits to be transferred from the account A of the merchant to the account A of the consumer. In the given example, the amount of the purchase (1,000 dollars) exceeds the minimum amount required for obtaining a discount (100 dollars) and an amount of credits equal to the 10% of the purchase is assigned (in this case, 100 credits).

The system now queries the Credit Decumulation Rules database to verify whether the type of the transaction requires a preliminary decumulation of credits. In this case, in correspondence to the search key (FIRST ACCOUNT MEMBER CATEGORY=‘M’; FIRST ACCOUNT TYPE=‘A’; COUNTERPART MEMBER CATEGORY=‘C’; COUNTERPART ACCOUNT TYPE=‘A’), the database indicates a decumulation rate of 0 as regards the merchant's account and a decumulation rate of 0,01 as regards the consumer's account. In this example, since the start balance of the consumer's account is 0, no decumulation occurs. If the balance were positive, the calculated amount of credits would be decumulated from the account A of the consumer to the account B of the same consumer.

The system now proceeds to verify the solvency of merchant's account “A” in the Account database:

ACCOUNT NUMBER=‘00031’→ACCOUNT TYPE=‘A’→CURRENT BALANCE=‘1,000’.

If the outcome is negative, the transaction is canceled and data is sent to the server 220 to indicate a negative outcome. The monetary transaction is also canceled, and a negative message is sent to the merchant's POS terminal.

If, on the other hand, the outcome is positive, i.e. the balance on merchant's account “A” is greater than the amount of credits that need be transferred to the consumer's account “A”, the system activates the monetary transaction authorization process (in this example: 1,000 dollars) through the channels connecting the server to the banking system. The connection to the banking system may be handled either by the server 220 or by the host.

In the case the monetary transaction is not authorized, the negative outcome of both transaction is sent to the POS terminal.

On the contrary, if the monetary transaction is authorized, the system completes the transaction by updating the Transaction database, the Account Movements database and the Account database with the new balance of the accounts modified by the transaction.

It has therefore been shown that the present method and system fulfils the proposed aim and objects. Clearly, several modifications will be apparent to and can be readily made by the skilled in the art without departing from the scope of the present invention. For instance, some parts of the system implementation as described in respect of a preferred embodiment are well known in the transaction card industry, like processes for registration of circuit members, transaction authorization, transfer of credits and account reconciliation, and so they have not been discussed in-depth.

Moreover, the accounts of the members 20, 30, 40 may or may not be associated with a physical card, such as credit or debit card, magnetic stripe card, smart card, digital wallet, internet card, or the like. Similarly, communication of id codes and data may take place over any computerized network suitable for the exchange of analog or digital information, such as the Internet, an intranet, an extranet, WAN, LAN, satellite or wireless communications or the like. Members can be connected to the network via any user interface system known in the art. As such, this system may include, but is not limited to, online or offline computer networked systems using various transfer protocols, WAP networked systems, telephone interactive voice response systems, interactive TV and the like. Similarly, data processing can be realized using any kind of personal or network computer, workstation, mainframe, or the like, running any operating system such as any version of Windows, MacOS, OS/2, OS/390, BeOS, Linux, UNIX, or the like.

Therefore, the scope of the claims shall not be limited by the illustrations or the preferred embodiments given in the description in the form of examples, but rather the claims shall encompass all of the features of patentable novelty that reside in the present invention, including all the features that would be treated as equivalents by the skilled in the art.

What is claimed is:

1. A method of managing and circulating credits within the members of a credit circuit, an amount of credits being issued by a participant enrolled in a first category of the circuit to at least one participant enrolled in a second category of the circuit, said issue being based on transaction data, wherein the credits are subject to an automatic transfer process according to a time-based algorithm.

2. The method according to claim 1, wherein a first automatic transfer process comprises the steps of:
a) retrieving first information data concerning the status of an account of type α of the participant in the second category;
b) performing a computation based on time and on the first information data;
c) transferring an amount of credits based on said computation from the account of type α to an account of type β of the participant in the second category.

3. The method according to claim 2, wherein credits from the account of type α of the participant in the second category are restricted to transfers to an account of a participant in the first category or to an account of type α of a another participant in the same category; and credits from the second account of the participant in the second category are restricted to transfer to an account of a participant in a third category or to an account of type β of another participant in the same category.

4. The method according to claim 2, wherein credits are transferred from an account of either type of the participant in the second category to an account of a corresponding type of a second participant in the second category.

5. The method according to claim 1, wherein the first category comprises a plurality of merchants.

6. The method according to claim 1, wherein the first category comprises at least one clearing center.

7. The method according to claim 1, wherein the first category comprises a plurality of consumers.

8. The method according to claim 1, wherein the first category comprises a plurality of nonprofit organizations.

9. The method according to claim 1, wherein the second category comprises a plurality of merchants.

10. The method according to claim 1, wherein the second category comprises at least one clearing center.

11. The method according to claim 1, wherein the second category comprises a plurality of consumers.

12. The method according to claim 1, wherein the second category comprises a plurality of nonprofit organizations.

13. The method according to claim 1, wherein said amount of credits is calculated according to a criterion defined by the participant in the first category.

14. The method according to claim 2, wherein the second category comprises the first category.

15. The method according to claim 2, wherein said computation follows the expression: s_{new}=(1−i)ⁿ*s_{old}, d_{new}=d_{old}+(s_{old}−s_{new}), where “s” indicates the balance of the account of type α, “d” indicates the balance of the account of type β, “i” is a time-based automatic transfer rate and “n” is the time elapsed since a last operation was made by the participant in the second category on either account.

16. The method according to claim 2, wherein the third category comprises a plurality of merchants.

17. The method according to claim 2, wherein the third category comprises at least one clearing center.

18. The method according to claim 2, wherein the third category comprises a plurality of consumers.

19. The method according to claim 2, wherein the third category comprises a plurality of nonprofit organizations.

20. The method according to claim 2, wherein credits are restricted to transfer from the account of the participant in the third category to an account of a participant in the first category.

21. The method according to claim 2, wherein credits are restricted to transfer from the account of the participant in the third category to an account of a participant in the second category.

22. The method according to claim 2, wherein credits are restricted to transfer from the account of the participant in the third category to an account of a second participant in the third category.

23. The method according to claim 2, wherein a second automatic transfer process comprises the steps of:
a) retrieving second information data concerning the status of the account of type β of the participant in the second category;
b) performing a computation based on time and on the second information data;
c) transferring an amount of credits based on said computation from the account of type β of the participant in the second category to a plurality of accounts of participants in a fourth category, according to a second algorithm.

24. The method according to claim 23, wherein the fourth category comprises the first, the second or the third category.

25. The method according to claim 23, wherein the fourth category comprises at least one clearing center.

26. The method according to claim 23, wherein the second information data comprises the period “m” of time elapsed since a last operation was made by the participant in the second category on any of his accounts and said second algorithm is based on a volume of operations that have occurred in the period “m” on the plurality of accounts of the participants in the fourth category.

27. The method according to claim 2, wherein a third automatic transfer process comprises the steps of:
a) retrieving third information data concerning the status of the account of the participant in the third category;
b) performing a computation based on time and on the third information data;
c) transferring an amount of credits based on said computation from the account of the participant in the third category to a plurality of accounts of participants in a fourth category, according to a third algorithm.

28. The method according to claim 27, wherein the fourth category comprises the first, the second or the third category.

29. The method according to claim 27, wherein the fourth category comprises at least one clearing center.

30. The method according to claim 27, wherein said information data comprises the period “m′” of time elapsed since a last operation was made by the participant in the third category on his account and the third algorithm is based on the volume of operations occurred on the plurality of accounts of the participants in the fourth category.

31. The method according to claim 1, wherein the automatic transfer process comprises the steps of:
a) retrieving first information data concerning the status of an account of a participant in either category;
b) performing a computation based on time and on the first information data;
c) canceling from said account an amount of credits based on said computation.

32. The method according to claim 1, wherein the automatic transfer process comprises the steps of:
a) retrieving first information data concerning the status of an account of the participant in either category;
b) performing a computation based on time and on the first information data;
c) transferring an amount of credits based on said computation from said account to at least one second account.

33. The method according to claim 1, wherein the automatic transfer process comprises the steps of:
a) retrieving first information data concerning the status of an account of the participant in either category;
b) performing a computation based on time and on the first information data;
c) transferring an amount of credits based on said computation from said account to at least one clearing center.

34. A system for managing and circulating credits within the members of a credit circuit, comprising means for enrolling participants, means for assigning the participants to a category and for assigning one or more credit accounts of different types to each of the participants, means for transferring credits from a first account to a second account according to transaction data, and means for automatically transferring credits from an account of a type to an account of a type according to a time-based algorithm.
